(19) United States
(12) Patent Application Publication
(10) Pub. No.: US 2016/0088336 A1
(43) Pub. Date: Mar. 24, 2016

(54) METHOD FOR OPERATING A CONDITIONAL ACCESS SYSTEM FOR BROADCAST APPLICATIONS

(71) Applicant: IRDETO B.V., Hoofddorp (NL)

(72) Inventor: Andrew Augustine Wajs, Hoofddorp (NL)

(21) Appl. No.: 14/868,443

(22) Filed: Sep. 29, 2015

Related U.S. Application Data
(63) Continuation of application No. 10/124,177, filed on Apr. 16, 2002, now abandoned.

(51) Int. Cl. H04N 21/266; H04N 21/4623; H04N 21/6334; H04N 21/418

(52) U.S. Cl. CPC H04N 21/26606; H04N 21/4181; H04N 21/4623; H04N 21/63345

(57) ABSTRACT

In a method for operating a conditional access system for broadcast applications, which conditional access system comprising a number of subscribers, each subscriber having a terminal including a conditional access module (11) and a secure device (12) for storing entitlements, each entitlement indicating a service for which the subscriber receiving the entitlement is entitled to watch, entitlement management messages (EMM's) are sent to a secure device or group of secure devices. These EMM's each provide an entitlement and a corresponding expiry date, wherein the entitlements are refreshed periodically in accordance with their expiry dates by sending EMM's updating the expiry dates. Further, a set of extension entitlement management messages (extension EMM's) is sent to all secure devices, each message indicating that all entitlements having an expiry date within a predetermined first period are extended with a predetermined second period, wherein the EMM's updating the expiry dates are sent after the extension EMM's.

The present application is a continuation of U.S. application Ser. No. 10/124,177, filed Apr. 16, 2002 (now pending), which is the United States national stage of International Application No. PCT/EP00/09868, filed Oct. 4, 2000, which claims priority to European Patent Application No. 99203415.7, filed Oct. 18, 1999, the entire contents of which are incorporated herein by reference.

The invention relates to a method for operating a conditional access system for broadcast applications, said conditional access system comprising a number of subscribers, each subscriber having a terminal including a conditional access module and a secure device for storing entitlements, each entitlement indicating a service for which the subscriber receiving the entitlement is entitled to watch, wherein entitlement management messages (EMM's) are sent to a secure device or group of secure devices, said EMM's each providing an entitlement and a corresponding expiry date, wherein the entitlements are refreshed periodically in accordance with their expiry dates by sending EMM's updating the expiry dates.

Such a method is known and is for example used in a pay television broadcasting system. If the updating or refreshment EMM's are not received before the expiry date, the secure devices will not allow access to the service or services for which the secure devices were entitled. Subscribers often disconnect their terminal equipment or tune their terminal to a broadcasting signal on which there are no EMM's carried. In such circumstances the refreshment EMM will not be received in time before the expiry date. In this manner subscribers will be forced to wait to be entitled over the air. In view of bandwidth constraints and the number of entitlements and number of subscribers in the conditional access system, the wait time can be extensive. Typically, if a subscriber needs to wait beyond a period of about thirty seconds, he will contact the subscriber management centre to be re-authorised. This results in a large number of telephone calls needed to be processed each time an entitlement expires unintendedly. Consequently, higher operational costs arise. To improve the time needed to perform a refreshment of all subscribers, techniques such as group addressing have been developed. Despite such developments, in case of a large base of subscribers, long wait times could still arise. These problems due to bandwidth limitations for the EMM messages make the operation of this type of conditional access system with positive authorisation very difficult with large numbers of sub scribers .

The invention aims to provide a method of the above-mentioned type wherein these problems of long wait times are avoided.

According to the invention a method of the above-mentioned type is provided, characterized in that a set of extension entitlement management messages (extension EMM's) is sent to at least a part of all secure devices, each message indicating that all entitlements having an expiry date within a predetermined first period are extended with a predetermined second period, wherein EMM's updating the expiry dates are sent after the extension EMM's.

In this manner it is obtained that during the first period all entitlements of at least a part of all secure devices are extended by sending the extension EMM's during the first period to thereby extend the entitlements during the second period. After sending these extension EMM's, the normal updating or refreshment EMM's can be sent for updating each entitlement at each subscriber individually.

According to the invention an alternative embodiment is characterized in that each EMM comprises an entitlement expiry date and an entitlement receipt date, which dates are stored in the secure device, wherein a set of extension entitlement management messages (extension EMM's) is sent to all secure devices, each message indicating a given date from which all entitlements of the secure device have not changed, wherein if the receipt date for any entitlement is after said given date, all entitlements are extended with a predetermined second period, wherein EMM's updating the expiry dates are sent after the extension EMM's.

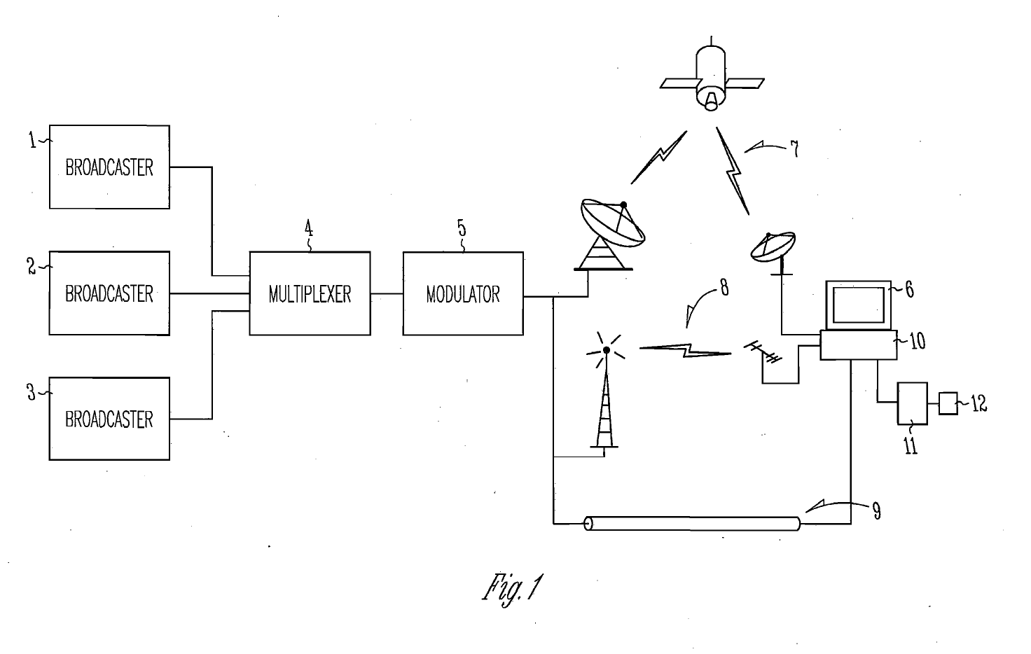

The invention will be further explained by reference to the drawing included in FIG. 1 showing a broadcast application in which an embodiment of the method of the invention is implemented.

In the broadcasting application shown, three broadcasters 1-3 are coupled with a multiplexer unit 4 comprising means for scrambling, encoding and compressing broadcast signals provided by the broadcasters 1-3. The thus obtained digital data streams are multiplexed into a digital transport stream, for example in accordance with the MPEG-2 standard. In the embodiment shown this digital transport stream is modulated by way of a modulator 5 before transmission. The operator of the equipment including the multiplexer unit 4 and modulator 5 is responsible for transmitting the signal to the receiving equipment of the public, one television set 6 being shown by way of example. The transmission of the signal may be carried out through one or more telecommunication channels including a satellite link 7, terrestrial link 8 or a cable system 9. One or more of the broadcasters 1-3 may be private broadcasters operating according to the concept of pay television, which implies subscription. This means that people wishing to view programs broadcasted by a particular broadcaster, have to subscribe to such a broadcast, and pay the appropriate fee.

Access to anyone of the broadcast signals provided by the broadcasters 1-3 requires a terminal 10 which for the subscription requiring services includes a conditional access module 11 and a secure device 12, generally provided in the form of a smart card which can be connected to the conditional access module 11. The remaining part of the terminal 10 is known as such and needs not be described in detail.

Regarding the conditional access to the services requiring subscription, it is known as such to send entitlement management messages or EMM's and entitlement control messages or ECM's to the subscribers, i.e. to the smart cards 12.

It is noted that in the present specification the term “service” indicates any type of program for which an entitlement is needed, including a channel, a specific event or any other item of interest.

In such a conditional access system, generally a positive authorisation mechanism is used for entitlement control. An EMM is sent to a smart card or a group of smart cards using either individual or group addressing, the EMM indicating that a card is entitled to watch a service. Each subscriber can have a number of entitlements for different services. The entitlement structure generally comprises an identification or entitlement number and an entitlement expiry date. This information is stored in the smart card 12. In this manner certain forms of piracy are avoided. However, it is necessary to send refreshment EMM's updating the expiry date. If such a refreshment or updating EMM for a specific entitlement is not received before the expiry date, the smart card 12 will not allow access to the service involved. In practice subscribers often disconnect their terminal equipment or tune their terminal to a broadcasting signal on which there are no EMM's carried. In such circumstances the refreshment EMM will not be received in time before the expiry date. This may cause a large number of telephone calls needed to be processed at the subscriber management centre and this causes high operational costs.

Even with the use of group addressing techniques a long period of time is required to update all entitlements at all subscribers. As an example in a practical broadcast application a conditional access system may comprise 10 million subscribers and 120 active entitlements. With a practical capacity for EMM's of 200 Kbit/s, a potential wait time of 2.5 hours before a refreshment EMM for a predetermined service arrives, is obtained.

According to the present invention, expiry of an entitlement by not receiving a refreshment EMM before the expiry date is prevented in the following manner.

A set of extension entitlement management messages or extension EMM's is sent to the entire base of smart cards 12, either using group addressing or individual addressing. Each extension EMM indicates to a smart card 12 that all entitlements with an expiry date within a predetermined first period, i.e. with an expiry date within a specified number of days, can remain active for a predetermined second period. In this manner the entitlements of all smart cards are extended for the second period. During the thus obtained period in which the smart cards will allow access to the services for which entitlements are stored, the normal updating EMM's can be sent to the subscribers updating the entitlements of the smart cards in a normal manner for a next period. As the extension EMM's refer to all entitlements stored in the smart card, the extensions can be provided to all smart cards in a relatively short time. Thereafter sufficient time is available to update all individual subscriptions within the entire base of subscribers.

In case group addressing is used, all entitlements of all subscribers are first extended in the described manner. Thereafter, individual refreshment EMM's can be forwarded, wherein these refreshment EMM's are first sent to those subscribers which have changed their subscription, for example by terminating or adding one or more subscriptions to specific services.

It is also possible to send the extension EMM's using individual addressing, wherein those addresses where subscriptions have been terminated do not receive the extension EMM's. It is further possible to add individual EMM's to the set of extension EMM's, wherein the individual EMM's update the expiry date of the unchanged subscriptions only.

As an alternative, an EMM could store not only an entitlement expiry date but also an entitlement receipt date in the smart card. In the above-described manner a set of extension EMM's is sent to the entire base of smart cards 12. In this case each extension EMM indicates a date from which the entitlements of a smart card have not changed. If the entitlement receipt date for any entitlement is after the date provided by the extension EMM, the smart card extends the expiry date of any entitlement by the predetermined second period.

In the embodiments described the conditional access module 11 and the secure device 12 are shown as physically separate devices. It will be understood that the conditional access module and/or the secure device can also be part of the terminal 10 or implemented in the terminal 10 by suitable programming. Therefore, the terms conditional access module 11 and secure device 12 as used in the specification and claims are not restricted to physically separate parts.

The invention is not restricted to the above-described embodiments which can be varied in a number of ways within the scope of the claims.

1-5. (canceled)

6. A method for operating a conditional access system for broadcast applications, said method comprising:
sending one or more entitlement management messages to a respective secure device of each of a number of subscribers,
wherein each entitlement management message provides a respective entitlement and a corresponding expiry date for the entitlement,
wherein each subscriber has a respective terminal including a conditional access module and said respective secure device for storing entitlements, and
wherein each entitlement indicates a respective service for which the subscriber receiving said entitlement is entitled to watch;
refreshing each entitlement periodically in accordance with the corresponding expiry date by sending refreshment entitlement management messages updating the expiry dates; and
sending a set of extension entitlement management messages to the secure devices, each of the extension entitlement management messages indicating, to each secure device, that all entitlements stored by said secure device that have a corresponding expiry date within a predetermined first period are extended so as to remain active for a predetermined second period;
wherein said sending refreshment entitlement management messages occurs after said sending a set of extension entitlement management messages.

7. A method for operating a conditional access system for broadcast applications, said method comprising:
sending one or more entitlement management messages to a respective secure device of each of a number of subscribers,
wherein each entitlement management message provides a respective entitlement, a corresponding expiry date for the entitlement, and a corresponding receipt date for the entitlement,
wherein each subscriber has a respective terminal including a conditional access module and said respective secure device for storing entitlements, and
wherein each entitlement indicates a respective service for which the subscriber receiving said entitlement is entitled to watch;
refreshing each entitlement periodically in accordance with the corresponding expiry date by sending refreshment entitlement management messages updating the expiry dates; and
sending a set of extension entitlement management messages to the secure devices, each of the extension entitlement management messages indicating, to each secure device, a given date from which all entitlements stored by said secure device have not changed, wherein if the receipt date for any entitlement stored by said secure device is after said given date, all entitlements stored by said secure device are extended so as to remain active for a predetermined period;
wherein said sending refreshment entitlement management messages occurs after said sending a set of extension entitlement management messages.

8. The method according to claim 6, wherein the extension entitlement management messages are sent using group addressing.

9. The method according to claim 6, wherein the extension entitlement management messages are sent using individual addressing.

10. The method according to claim 6, wherein the set of extension entitlement management messages comprises individual entitlement management messages for predetermined secure devices for which a subscription has changed, said individual entitlement management messages updating the expiry date of unchanged subscriptions only.

11. The method according to claim 7, wherein the extension entitlement management messages are sent using group addressing.

12. The method according to claim 7, wherein the extension entitlement management messages are sent using individual addressing.

13. The method according to claim, 7, wherein the set of extension entitlement management messages comprises individual entitlement management messages for predetermined secure devices for which a subscription has changed, said individual entitlement management messages updating the expiry date of unchanged subscriptions only.
